(19) United States
(12) Patent Application Publication
(10) Pub. No.: US 2008/0102906 A1
(43) Pub. Date: May 1, 2008

(54) COMMUNICATION SYSTEM AND METHOD OF OPERATING THE SAME

(75) Inventors: Evert DIJKSTRA, Fontaines (CH); Francois MARQUIS, Oron-le-Chatel (CH)

Correspondence Address: ROBERTS, MLOTKOWSKI & HOBBES, P. O. BOX 10064, MCLEAN, VA, 22102-8064, US

(73) Assignee: PHONAK AG, Staefa (CH)

(21) Appl. No.: 11/554,120

(22) Filed: Oct. 30, 2006

(51) Int. Cl. H04M 1/00

(52) U.S. Cl. 455/575.2; 455/575.6

(57) ABSTRACT

There is provided a communication system, comprising a transmission unit to be worn at a user's body at or below the user's neck for transmitting audio signals via an inductive link; and an earpiece to be worn at least in part in the user's ear canal including a receiver unit for receiving audio signals via said inductive link from the transmission unit, an audio signal processing unit for processing audio signals received by the receiver unit, and a loudspeaker stimulating the user's hearing according to the processed audio signals; wherein said inductive link is an amplitude modulation inductive link having a carrier frequency of from 100 kHz to 30 MHz.

### BACKGROUND OF THE INVENTION

1. Field of the Invention

The present invention relates to a communication system comprising a transmission unit to be worn at a user's body at or below the user's neck for transmitting audio signals via an inductive link, and an earpiece to be worn at least in part in the user's ear canal including a receiver unit for receiving audio signals via the inductive link from the transmission unit, an audio signal processing unit for processing audio signals from the receiver unit and a loudspeaker stimulating the user's hearing according to the processed audio signals.

2. Description of Related Art

Such systems are typically used for covert security applications, wherein the inductive receiver unit typically is so small that it can be placed completely in the user's ear canal and thus can act as a hidden wireless loudspeaker for a radio frequency system, with the audio signals transmitted by the transmission unit being supplied by a radio frequency (RF) receiver device, such as a walkie-talkie or a mobile phone, worn by the user, to which device the transmission unit may be connected via a cable. The transmission unit typically comprises an inductive loop which is worn around the user's neck, around the user's arm or over the user's shoulder and which serves as the antenna. The inductive loop generates a magnetic field received by the receiver unit placed in the user's ear canal. Typically, the amplitude of the inductive field is modulated directly by the audio signals to be transmitted over the inductive link (“base band modulation”). For such a based band modulation the transmitted frequencies inherently are in the audio signal range.

However, nowadays many magnetic perturbations are generated in the audio band by modern electronics. Typical sources of such magnetic perturbations in the audio band are cars, tramways, trains, anti-theft systems, airport scanner systems, neon lights, 50/60 Hz of AC power lines, PC screens and TV devices. Such sources of magnetic perturbations are often present in areas where covert security is present and needed. The level of perturbation often is so high that the use of an inductive receiver is no more possible for covert applications. This is particularly the case in modern cars, tramways, airplanes and super markets with anti-theft systems. Another disadvantage of based band inductive systems is that due to the lack of coding or modulation it can be relatively easily caught by a third person placed just near the transmission unit (in contrast to radio frequency links, inductive links have a relatively short range).

U.S. Pat. No. 5,774,791 relates to a wireless communication system comprising a transmission unit worn around the user's neck including an inductive loop, a RF receiver for receiving audio signals from a remote microphone through a RF transmission system, and a time variant modulation (TVM) pulse generator having a pulse repetition rate which is at least 2.6 times the frequency of the highest audio signal frequency component. The system further comprises a receiver unit which comprises a TVM demodulator and which may be configured as a behind the ear (BTE) hearing aid or in the ear (ITE) hearing aid.

EP 1 250 026 A1 relates to a binaural hearing assistance system comprising a inductive link between the two hearing aids or between the hearing aids and a remote programming device. The inductive link may be modulated, such as by alternate mark inversion (AMI), TVM, NRZ and RZ.

U.S. Pat. No. 5,734,976 relates to a base band inductive link to an earpiece receiver wherein the interference with magnetic disturbators is addressed by digital signal processing in the receiver.

U.S. 2004/175009 A1 relates to a data transmission unit for hearing aids for creating an inductive link which may be amplitude modulated or FSK (frequency shift keying) modulated.

It is an object of the invention to provide for a communication system having an inductive link from a body-worn audio signal transmission unit to an earpiece comprising a loudspeaker, which can be used also in the presence of sources of magnetic perturbations and which is nevertheless relatively easy to implement. It is also an object of the invention to provide for a method of operating such communication system.

### SUMMARY OF THE INVENTION

According to the invention these objects are achieved by a communication system as defined in claim 1 and a method as defined in claim 23, respectively.

The invention is beneficial in that, by providing for an amplitude modulation (AM) inductive link having a carrier frequency of from 100 kHz to 30 MHz, the link is less susceptible to magnetic perturbations which may be present primarily within the audio frequency range in many everyday surroundings, such as cars, tramways, trains, airports, supermarkets and stores, etc. Thus the system according to the invention can be successfully used in many areas, and in particular also in most areas where covert security is needed. On the other hand, an AM inductive link is relatively easy to implement, as compared for example to a TVM inductive link, and does not need a specific integrated circuit (IC).

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWING

FIG. 1 is a schematic representation of the use of a communication system according to the invention for communication between two persons;

FIG. 2 is a schematic view of the communication system of FIG. 1 worn by one of the two persons;

FIG. 3 is a comparison of the spectrum of an audio signal base band link according to the prior art and an example of an AM audio signal link according to the invention;

FIG. 4 is a block diagram of an embodiment of the transmission unit of a communication system according to the invention;

FIG. 5 is a block diagram of another embodiment of the transmission unit of a communication system according to the invention; and

FIG. 6 is a block diagram of one embodiment of the receiver unit of a communication system according to the invention.

### DETAILED DESCRIPTION OF THE INVENTION

A preferred application of the present invention are miniature inductive transmission systems which are used when discrete communication is needed, for example, for security applications. A miniature inductive receiver unit is placed as an earpiece in or at the user's ear for acting as a wireless loudspeaker for an RF system, with the audio signals transmitted via the RF system being sent from a transmission unit worn at the user's body at or below the user's neck via an inductive link to the inductive receiver. Preferably the earpiece is adapted to be worn completely in the ear canal. However, in some applications the earpiece may be designed as a miniature BTE (behind-the-ear) device which comprises an internal loudspeaker and a sound tube extending from the internal loudspeaker into the ear canal or, alternatively, an external loudspeaker arranged in the ear canal and connected to the BTE-part by wires extending into the ear canal. Thus, in the case of a miniature BTE, only the sound tube or the external loudspeaker is worn in the user's ear canal.

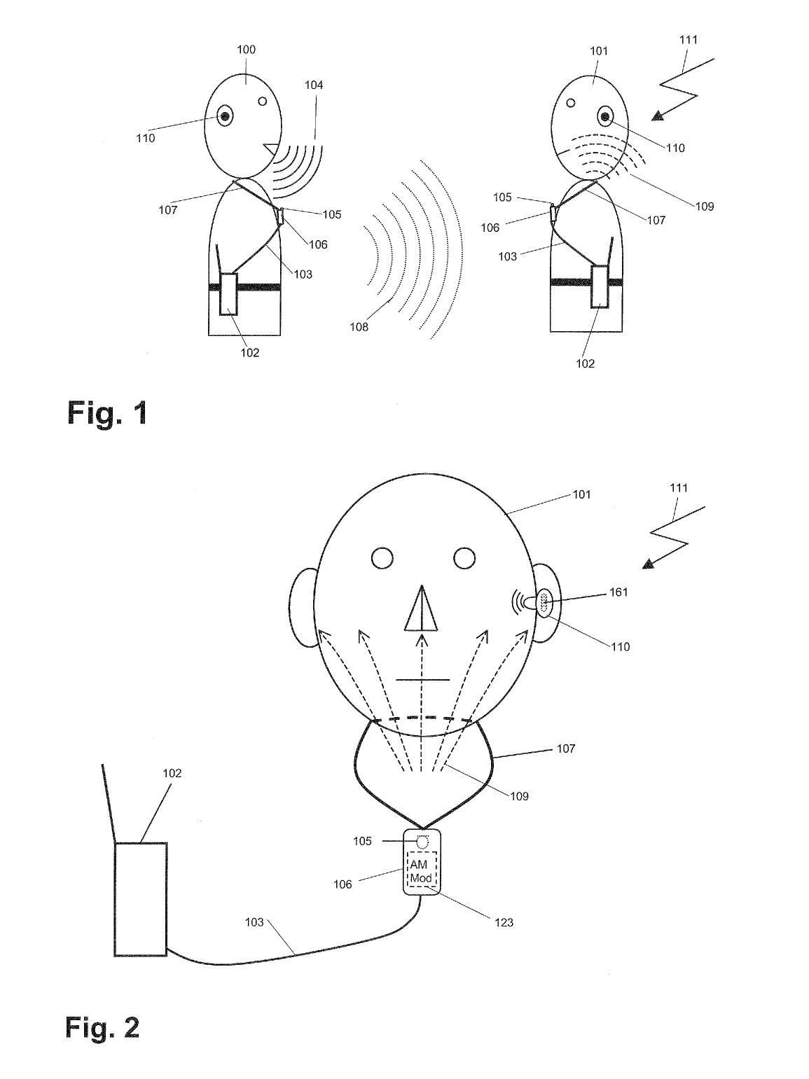

A typical application using such a miniature inductive communication system is shown in FIGS. 1 and 2.

A first user 100 uses a first communication system comprising a RF communication device 102, such as a walkie-talkie, for exchanging audio signals via a bi-directional RF link 108, for example a frequency modulation (FM) link, with a RF communication device 102 used by a second user 101, a transmission unit 106, and an earpiece 110. The RF communication device 102 may be worn, for example, at a belt around the user's waist.

The transmission unit 106 is electrically connected to the RF communication device 102 via a cable 103 which supplies the audio signals received by the RF communication device 102 to the transmission unit 106 and which serves to power the transmission unit 106. In addition, the cable 103 serves to supply audio signals captured by a microphone 105 of the transmission unit 106 to the RF communication device 102 which transmits them over the bi-directional RF link 108 to another RF communication device 102 used by the second user 101.

The transmission unit 106 is worn at a loop 107 around the user's neck, which also serves as an inductive loop antenna for transmitting the audio signals supplied by the RF communication device 102 to the earpiece 110 via an inductive link 109. The microphone 105 serves to capture the voice 104 of the user 100. The earpiece 110 is worn at least partially, and preferably completely, in the user's ear canal. If the earpiece is designed, as mentioned before, as a miniature BTE device, only the sound tube or the external loudspeaker is worn in the user's ear canal.

The second communication system used by the second user 101 is fully symmetrical to that used by the user 100. With the communication system of FIG. 1 the user 100 may communicate with the user 101 in that the voice 104 of the user 100 is captured by the microphone 105, the corresponding audio signals are transmitted via the RF link 108 from the RF communication device 102 of the user 100 to the RF communication device 102 of the user 101, the audio signals received there are supplied via the cable 103 to the transmission unit 106 of the user 101, and from there via the inductive link 109 to the earpiece 110 of the user 101, which renders the audio signals audible for the user 101 via the built-in miniature loudspeaker.

In many environments, such as in cars, tramways, trains, airports, supermarkets, etc., magnetic perturbations 111, mainly in the audio signal bandwidth, may be present. In order to avoid interference of such magnetic perturbations 111 with the inductive link 109, the inductive link 109 is designed as a AM link having a carrier frequency of from 100 kHz to 30 MHz, which range is far above the audio signal frequency range in which the magnetic perturbations primarily occur.

In some applications the RF communication device 102 and the transmission unit 106 could form an integrated device rather than being connected by a cable 103. Alternatively, the cable 103 could be replaced by a bidirectional wireless link such as a Bluetooth link. In this case, a power supply must be integrated in the transmission unit 106.

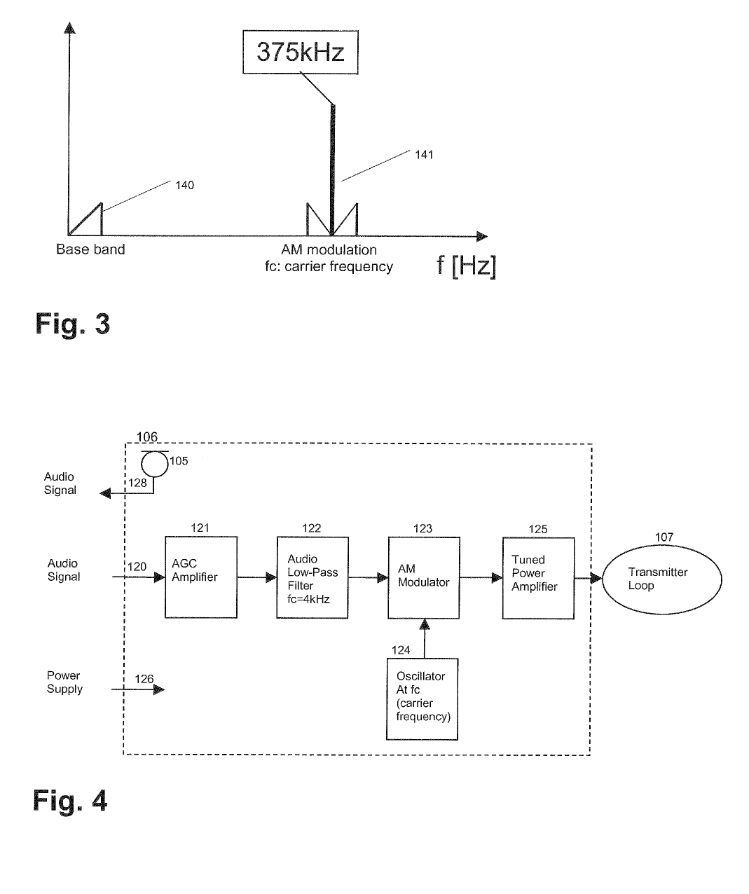

In FIG. 3 the typical spectrum of an inductive base band audio link 140 of the prior art is compared to a AM inductive audio link 141 according to the invention, with an example having a carrier frequency of 375 kHz being shown. The based band link 140 has a typical spectrum ranging from, for example, 200 Hz to 3.2 kHz (which is a typical audio range for walkie-talkies), whereas the spectrum of the AM link 141 has a peak at the carrier frequency, accompanied by two side bands representing the carrier frequency plus and minus the respective audio signal frequencies.

A first example of the structure of the transmission unit 106 is shown in FIG. 4. As already mentioned above, the transmission unit 106 comprises a microphone 105 for capturing the user's voice, with the audio signals 128 captured by the microphone 105 being supplied to the RF communication device 102 via the cable 103.

The audio signals received by the RF communication device 102 are supplied to the transmission unit 106 likewise via the cable 103. These audio signals 120 are supplied to an automatic gain control (AGC)-amplifier 121 which ensures that the inductive field of the inductive link 109 established by the transmitter loop 107 is never over-modulated. After the AGC-amplifier 121 the audio signals are filtered by a low-pass filter 122 in order to reduce the AM modulated audio signal bandwidth. Typically, the filter 122 will have a cut-off frequency of about 4 kHz, resulting in a modulated audio signal bandwidth of about 8 kHz. This is sufficient, since, as already mentioned above, the RF communication device 102, such as a walkie-talkie, will have an audio signal bandwidth of for example from 200 Hz to 3.2 kHz. The filtered audio signals are than modulated by an AM modulator 123 using an oscillator 124 to generate the AM modulated signal at the carrier frequency determined by the oscillator 124. The AM modulated signal then is amplified, filtered and transmitted to the transmitter loop 107 by a tuned power amplifier 125. This will ensure a maximum transmitted inductive field 109 with a minimum of harmonics.

As already mentioned above, the cable 103 also serves as a power supply 126 for the transmission unit 106.

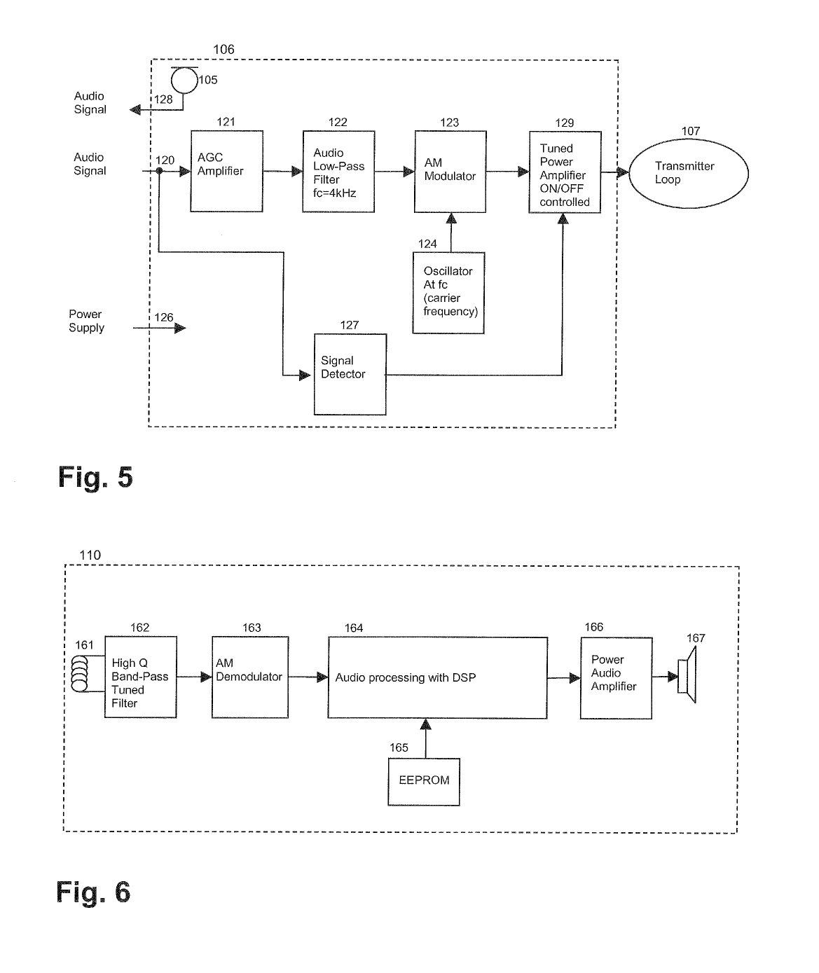

An alternative embodiment of the transmission unit 106 is shown in FIG. 5, wherein the tuned power amplifier 125 is activated only when actually an audio signal 120 is received from the RF communication device 102. To this end, the audio signals 120 are not only supplied to the AGC-amplifier 121 but also to a signal detector 127 which serves to detect whether an audio signal 120 is present at the cable 103 or not. Detection of the presence of an audio signal 120 in a very fast manner with an attack time of preferably less then 10 msec. Once the presence of an audio signal 120 has been detected by the signal detector 127, the signal detector 127 activates, i.e. turns on, the tuned power amplifier 125. Once the signal detector 127 has detected that no audio signal 120 is present, it will disable the transmission unit 106 by deactivating, i.e. turning off, the power amplifier 125. Such deactivation of the power amplifier 125 occurs with a release time constant of preferably a few 100 msec, for example from 100 to 3000 msec, in order to avoid that the power amplifier 125 is turned off during short speech pauses.

An example of the earpiece 110, i.e. the receiver unit, is shown in FIG. 6.

The inductive field of the inductive link 109 and eventually also magnetic perturbations 111, if present, are picked up by the inductive antenna 161 which is part of a band-pass tuned filter 162 having a high quality (Q) factor (e.g. 70) in order to provide for a selective filtering of perturbations outside the frequency range of the modulated audio signals of the inductive link 109, i.e. the carrier frequency plus and minus the audio signal frequencies. Preferably, the bandwidth of the band-pass filter 161/162 corresponds to the AM-modulated audio signal bandwidth determined by the low-pass filter 122 of the transmission unit 106, i.e. about 8 kHz in the present example (plus and minus 4 kHz). The filtered signal then is demodulated by an AM demodulator 163, with the demodulated audio signal then being processed by a powerful digital signal processor (DSP) 164 which serves to filter out all the remaining perturbations from the useful audio frequency range (which is typically from 200 Hz to 3.2. kHz, as mentioned above). Preferably both time domain and frequency domain signal processing are used so that very strong and efficient band-pass filtering can be achieved. Noise reduction and cancellation techniques also may be applied. Further, a gain model is implemented in the DSP 164 to control the maximum output power delivered to a miniature loudspeaker 167 via a power audio amplifier 166. The various audio signal processing parameters used by the DSP 164 are stored in a non-volatile memory, such as an EEPROM 165.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

What is claimed is:

1. A communication system, comprising:
a transmission unit to be worn at a user's body at or below a neck of said user for transmitting audio signals via an inductive link; and
an earpiece to be worn at least in part in an ear canal of said user including a receiver unit for receiving audio signals via said inductive link from said transmission unit, an audio signal processing unit for processing audio signals received by said receiver unit, and a loudspeaker for stimulating a hearing of said user according to said processed audio signals;
wherein said inductive link is an amplitude modulation inductive link having a carrier frequency of from 100 kHz to 30 MHz.

2. The system of claim 1, wherein said transmission unit comprises a low-pass filter for filtering said audio signals prior to undergoing amplitude modulation, which is adapted to ensure that a modulated audio signal bandwidth is less than 10 kHz.

3. The system of claim 1, wherein said transmission unit comprises an antenna designed as an inductive loop selected from the group consisting of a loop to be worn around said user's neck, a loop to be worn around said user's arm and a loop to be worn over said user's shoulder.

4. The system of claim 1, wherein said transmission unit comprises an automatic-gain-control amplifier adapted for avoiding over-modulation of said inductive link.

5. The system of claim 1, wherein said transmission unit comprises a signal detector for detecting the presence of audio signals to be transmitted via said inductive link.

6. The system of claim 5, wherein said signal detector is adapted to disable said transmission unit during times when no presence of audio signals to be transmitted via said inductive link is detected.

7. The system of claim 6, wherein said signal detector is adapted to switch on and off a power amplifier used for amplifying audio signals to be transmitted via said inductive link according to a presence of audio signals to be transmitted via said inductive link.

8. The system of claim 6, wherein said signal detector is adapted to detect a presence of audio signals to be transmitted via said inductive link with an attack time of less than 10 msec.

9. The system of claim 6, wherein said signal detector is adapted to disable said transmission unit with a release time constant of from 100 to 3000 msec.

10. The system of claim 1, wherein said receiver unit comprises an antenna, an amplitude modulation demodulator and a band-pass filter having a bandwidth substantially equal to a modulated audio signal bandwidth, said band-pass filter being adapted for filtering signals received by said antenna prior to being demodulated by said demodulator.

11. The system of claim 1, wherein said audio signal processing unit comprises a digital signal processor for processing audio signals demodulated by a demodulator.

12. The system of claim 11, wherein said digital signal processor is adapted to band-pass filter said audio signals demodulated by said demodulator.

13. The system of claim 11, wherein said digital signal processor is adapted to process said audio signals demodulated by said demodulator both in time domain and in frequency domain.

14. The system of claim 11, wherein said digital signal processor applies a gain model to control a maximum output power delivered to said loudspeaker.

15. The system of claim 11, wherein said audio signal processing unit comprises a non-volatile memory for storing audio signal processing parameters to be used by said digital signal processor.

16. The system of claim 1, wherein the system comprises a receiver device for receiving audio signals via a wireless link, which is connected to or integrated with said transmission unit, said receiver device being adapted to supply said received audio signals to said transmission unit.

17. The system of claim 16, wherein said wireless link is a radio frequency link.

18. The system of claim 16, wherein said transmission unit is connected to said receiver device via a cable.

19. The system of claim 18, wherein said transmission unit is powered by said receiver device via said cable.

20. The system of claim 16, wherein said transmission unit comprises a microphone for capturing audio signals from a voice of said user.

21. The system of claim 20, wherein said wireless link is bidirectional and wherein said audio signals captured by said microphone of said transmission unit are supplied to said receiver device for being transmitted via said wireless link.

22. The system of claim 1, wherein said earpiece is adapted to be worn completely in said user's ear canal.

23. A method of operating a communication system comprising a transmission unit to be worn at a body of a user at or below a neck of said user and an earpiece to be worn at least in part in an ear canal of said user, comprising
supplying audio signals to said transmission unit,
transmitting said audio signals from said transmission unit to said earpiece via an inductive link, and
stimulating a hearing of said user via said earpiece according to audio signals received by said earpiece,
wherein said inductive link is an amplitude modulation inductive link having a carrier frequency of from 100 kHz to 30 MHz.
